(19) United States
(12) Patent Application Publication
(10) Pub. No.: US 2008/0282150 A1
(43) Pub. Date: Nov. 13, 2008

(54) FINDING IMPORTANT ELEMENTS IN PAGES THAT HAVE CHANGED

(76) Inventors: Anthony Wayne Erwin, Rochester, MN (US); Timothy Charles Mossing, Fishers, IN (US); Christopher A. Peterson, Rochester, MN (US); Brian Owen Wood, Byron, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/746,737

(22) Filed: May 10, 2007

(51) Int. Cl. G06F 17/00; G06F 7/00

(52) U.S. Cl. 715/255; 707/102; 707/E17.044; 715/234

(57) ABSTRACT

A page is received, which includes elements. A tree represents the page. A subset of the elements are displayed. In response to selection of an important element, a subtree is created, which includes a path from a root element of the tree to the important element. A changed page is received, which is represented by a changed tree. A second path in the changed tree is found, where a leaf element of the second path is different from the important element in the first path, and where all other elements in the first path and the second path match. A message is displayed, which indicates that the important element was changed. In various embodiments, the message is presented in audio, magnified, or touch form. In this way, the user is notified of changes to the page that the user has selected as important.

### FIELD

An embodiment of the invention generally relates to finding important elements in pages that have changed.

### BACKGROUND

Years ago, computers were isolated devices that did not communicate with each other. But, today computers are often connected in networks, such as the Internet or World Wide Web, and a user at one computer, often called a client, may wish to access information at multiple other computers, often called servers, via a network. Information is often stored at servers and sent to the clients in units of pages, which are connected together via embedded links, also known as hyperlinks. Sending information between servers and clients in units of pages works well, so long as the information changes infrequently. But, if the information changes frequently, e.g., if the page includes the text of an online chat session between users, stock market quotes, or a monitor of system activity, then retransmitting, the entire page even though only a few characters in the page have changed, is an inefficient use of computing resources and distracting for the user.

One technique for handling frequently-changing information is to transmit only an updated part of the page, without retransmitting the entire page from the server to the client. An example of such a technique is AJAX (Asynchronous JavaScript and XML (Extensible Markup Language)), which uses a combination of XHTML (Extensible Hypertext Markup Language) and Javascript. Such a technique has the advantages of increasing the page's interactivity, speed, and usability. But, such a technique can also have several disadvantages.

First, users of screen readers, may not be aware of updates because the screen reader is either unaware of the update at all, or because the screen reader treats the update as a page refresh, which causes the entire text of the page to be re-spoken, which is time-consuming and difficult for the user to listen to while attempting to remember which text might have changed. A screen reader verbalizes, or speaks, everything on the screen including text, graphics, control buttons, and menus in a computerized voice that is spoken aloud through a speaker. In essence, a screen reader transforms a graphical user interface (GUI) into an audio interface.

Second, users of screen magnifiers or of magnification features built into web browsers may not be aware of the update, or may see the update too late, if the update occurs in an area that is not currently within the magnified portion of the page. A screen magnifier enlarges a portion of the page, which can increase legibility.

Finally, users who are not looking at the updated portion of the video screen at the correct time (or who don't want to constantly monitor their screen for updates) might not notice the updated data. For example, users might be interested in a particular sports score, a particular stock quote, or the status of some system they are monitoring, but their attention is elsewhere at the time of the update, so they miss the change because pages are often cluttered with information, causing an update to go unnoticed unless the user is looking directly at the proper location when the update occurs.

Thus, what is needed is a better technique for handling updates to pages.

### SUMMARY

A method, apparatus, system, and storage medium are provided. In an embodiment a page is received, which includes elements. A tree represents the page. A subset of the elements are displayed in a format specified by another subset of the elements. A selection of an important element is received. In response to the selection, a subtree is created, which includes a path from a root element of the tree to the important element. A changed page is received, which is represented by a changed tree. A second path in the changed tree is found, where a leaf element of the second path is different from the important element in the first path, and where all other elements in the first path and the second path are identical and in the same order. A message is displayed, which indicates that the important element was changed. In various embodiments, the message is presented in audio, magnified, or touch form. In this way, the user is notified via the message of the changes to the page that the user has selected as important.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example user interface, according to an embodiment of the invention.

FIG. 3 depicts a block diagram of an example user interface for importance preferences, according to an embodiment of the invention.

FIG. 4 depicts a block diagram of example user interface for a refreshed or dynamically updated page, according to an embodiment of the invention.

FIG. 5 depicts a block diagram of an example data structure for profile data, according to an embodiment of the invention.

FIG. 6 depicts a block diagram of an example data structure for a page, according to an embodiment of the invention.

FIG. 7 depicts a block diagram of an example data structure for a tree that represents the page, according to an embodiment of the invention.

FIG. 8 depicts a block diagram of a saved subtree, according to an embodiment of the invention.

FIG. 9 depicts a block diagram of another saved subtree, according to an embodiment of the invention.

FIG. 10 depicts a flowchart of example processing for handling events, according to an embodiment of the invention.

FIG. 11 depicts a flowchart of example processing for receiving addresses of pages, according to an embodiment of the invention.

FIG. 12 depicts a flowchart of example processing for setting important elements, according to an embodiment of the invention.

FIG. 13 depicts a flowchart of example processing for handling importance preferences, according to an embodiment of the invention.

FIG. 14 depicts a flowchart of example processing for handling refresh and page dynamic updates, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment a page is received, which includes elements, such as control tags or formatting elements and data elements. A hierarchical tree data structure represents the page of elements. A subset of the elements (data elements) are displayed in a format specified by another subset of the elements (formatting elements or control tags). The user selects an important element, which may be data element in a specified page or a formatting element that applies to a specified page or to all pages within a domain. In response to receiving a page that matches the address of the specified page, a saved subtree is created, which includes a first path from a root element of the tree to the important element (in the case of an important data element) or to the child element of the important element (in the case of an important formatting element). A changed page is subsequently received, which is represented by a changed tree. The changed page may be received in the form of a refreshed page or a dynamic update to a portion of the elements of a previously received page. A second path in the changed tree is found, where a leaf element of the second path is different from the important element (or the child element for the case of the important formatting element) in the first path, and where all other elements in the paths match (all other elements up to the parent of the leaf element). A message is displayed, which indicates that the element was changed. In this way, the user is notified via the message of the changes to the page that the user has selected as important.

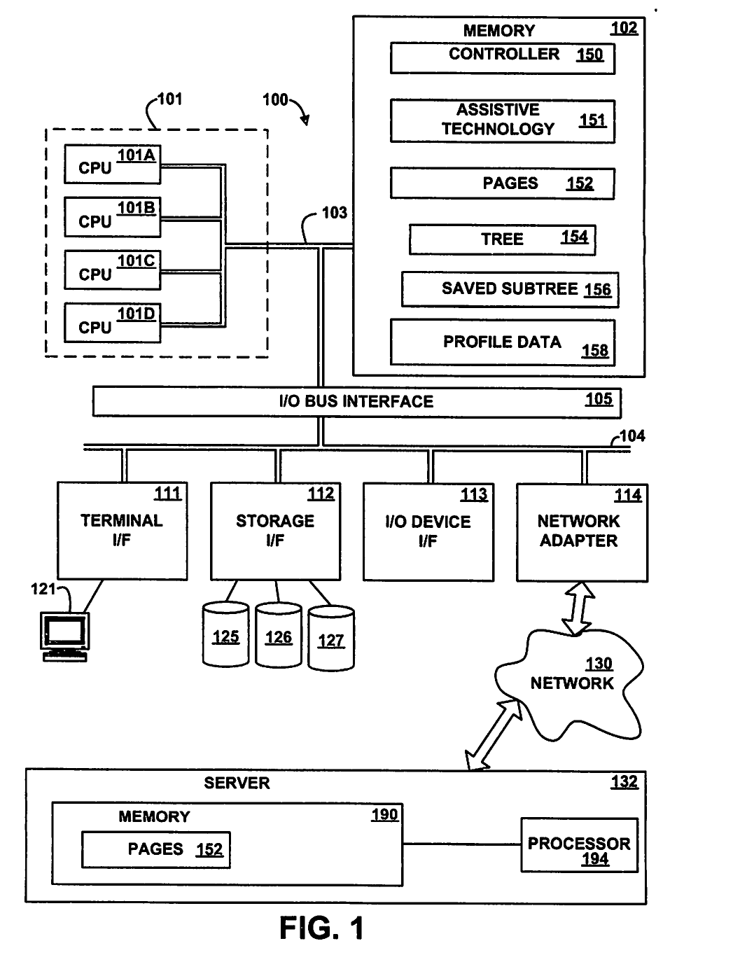

Referring to the Drawings, wherein like numbers denote like parts throughout the several views, FIG. 1 depicts a high-level block diagram representation of a client computer system 100 connected to a server computer system 132 via a network 130, according to an embodiment of the present invention. The terms “client” and “server” are used herein for convenience only, and in various embodiments a computer system that operates as a client in one environment may operate as a server in another environment, and vice versa. In an embodiment, the hardware components of the computer system 100 and 132 may be implemented by a IBM System i5 computer system and a ThinkPad T60 computer system, respectively, available from International Business Machines Corporation of Armonk, N.Y. But, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a controller 150, assistive technology 151, pages 152, a tree 154, a saved subtree 156, and profile data 158. Although the controller 150, the assistive technology 151, the pages 152, the tree 154, the saved subtree 156, and the profile data 158 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the controller 150, the assistive technology 151, the pages 152, the tree 154, the saved subtree 156, and the profile data 158 are illustrated as being contained within the main memory 102, these elements are not necessarily all completely contained in the same storage device at the same time. Further, although the controller 150, the assistive technology 151, the pages 152, the tree 154, the saved subtree 156, and the profile data 158 are illustrated as being separate entities, in other embodiments some of them, portions of some of them, or all of them may be packaged together.

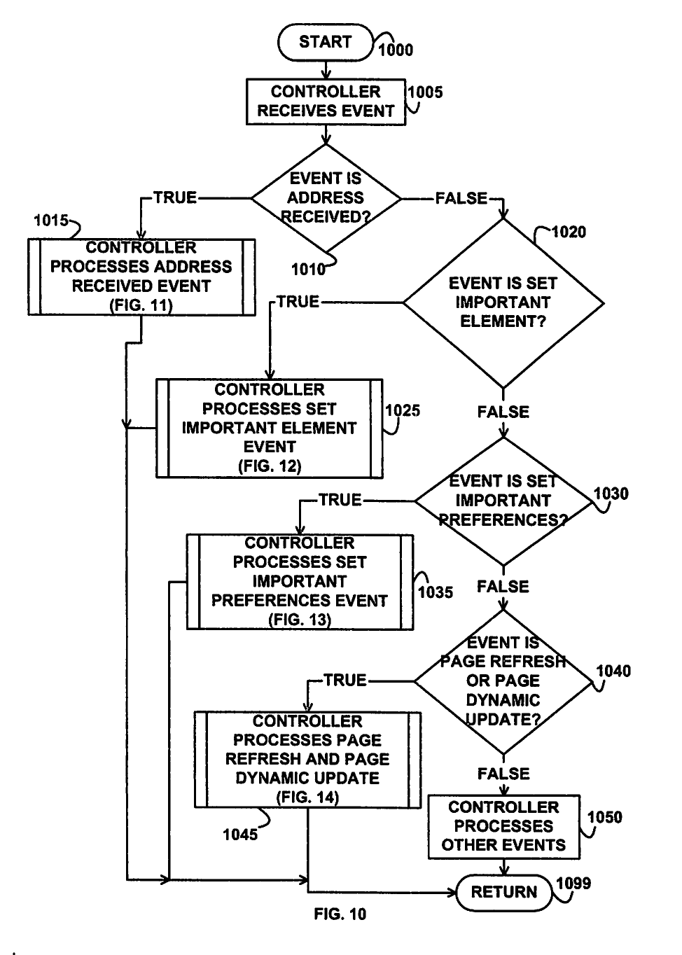

In various embodiments, the controller 150 may be implemented via an operating system, a user application, a third-party application, a browser, a plug-in for a browser, or any combination thereof. In various embodiments, the controller 150 includes instructions capable of executing on the processor 101 or statements capable of being interpreted by instructions that execute on the processor 101 to perform the functions as further described below with reference to FIGS. 10, 11, 12, 13, and 14. In another embodiment, the controller 150 may be implemented in hardware via logic cards, circuit cards, and/or other hardware elements. Since, as explained above, the controller 150 may include a combination of components, one component (e.g., a browser) may perform one action, such as retrieving the pages 152, while another component (e.g., a plug-in) performs another action, such as comparing the saved subtree 156 to a portion of the tree 154.

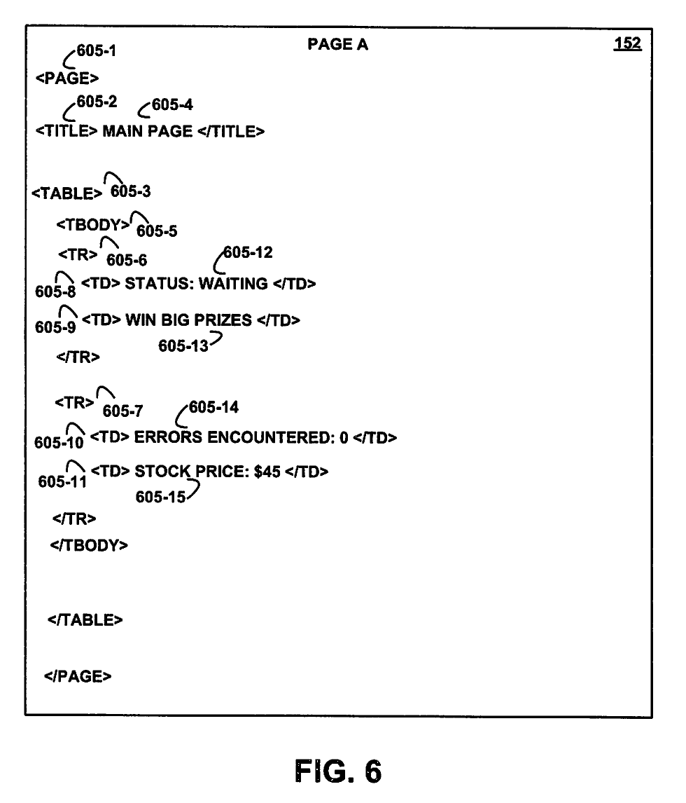

The controller 150 retrieves the pages 152 from the server computer system 132. The pages 152 may include any appropriate content that is capable of being retrieved by the controller 150 and interpreted, rendered, and/or formatted for display on the user terminal 121. Examples of content of the pages 152 include text, video, audio, images, objects, or any other appropriate data. The pages 152 may include elements, control tags, formatting tags, logic, control instructions, or control statements, which the controller 150 interprets or executes, in order to format the appearance of the pages 152 for display via the user terminal 121. Examples of elements include those that control font size, font style, line spacing, tables, column, borders, frames, fields, hyperlinks, paragraphs, and breaks. The pages 152 may be encoded using HTML (Hypertext Markup Language), XML (Extensible Markup Language), XHTML (Extensible Hypertext Markup Language), CSS (Cascading Style Sheets), JavaScript, any other appropriate protocol, or any combination thereof. An example of a page 152 is further described below with reference to FIG. 6.

The assistive technology 151 reads the pages 152 and other data capable of being displayed and communicates their information in another form, such as audio, magnified video, or touch (e.g., Braille output). In various embodiments, the assistive technology 151 may be implemented via a screen reader or a screen magnifier. A screen reader is a software application that attempts to identify and interpret what is being displayed on a video screen. This interpretation is then represented to the user with text-to-speech, sound icons, or a Braille output via the user terminal 121. A screen magnifier is software application that interfaces with the video output of the computer system 100 to present enlarged or magnified screen content. A screen magnifier allows a user to zoom in or out on portions of data displayed on a video screen.

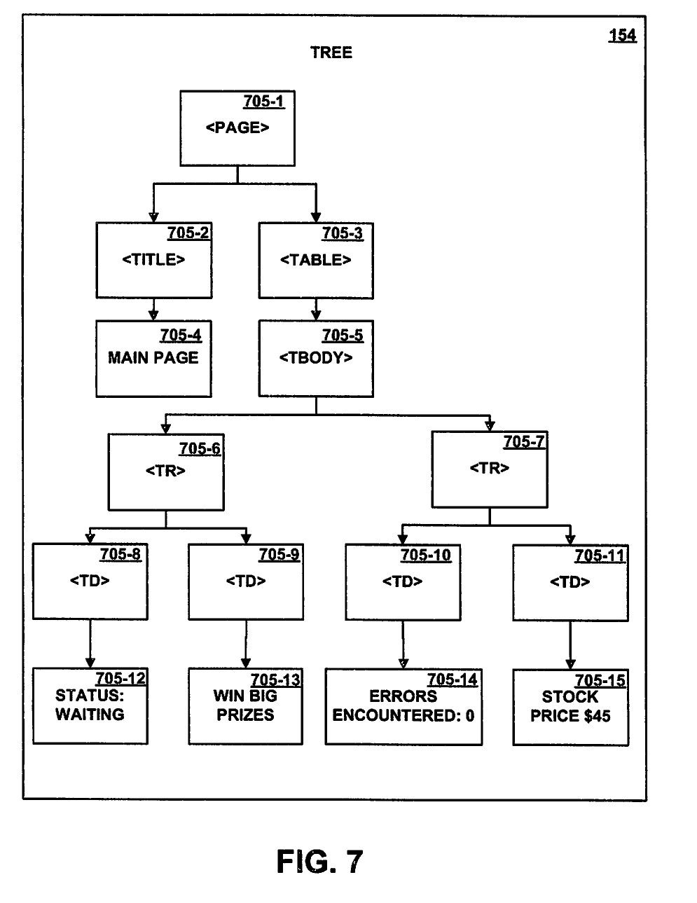

The tree 154 is a data structure that represents a page 152 as a tree-structure (a node tree), with the various formatting or control and data elements of the page 152 defined as nodes in a tree. An example of the tree 154 is further described below with reference to FIG. 7.

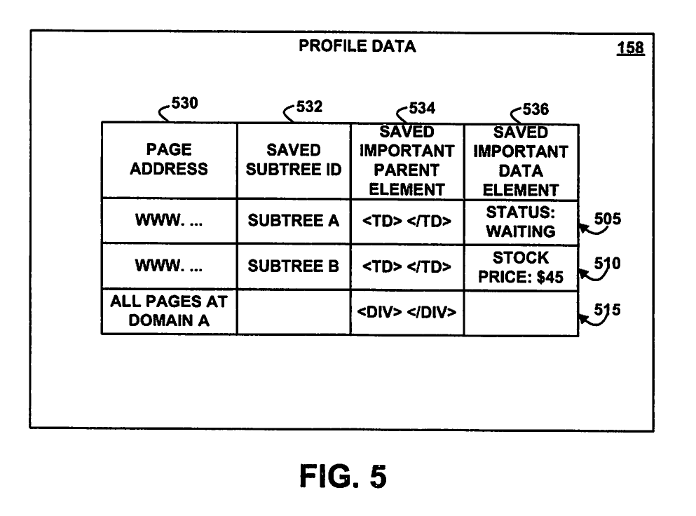

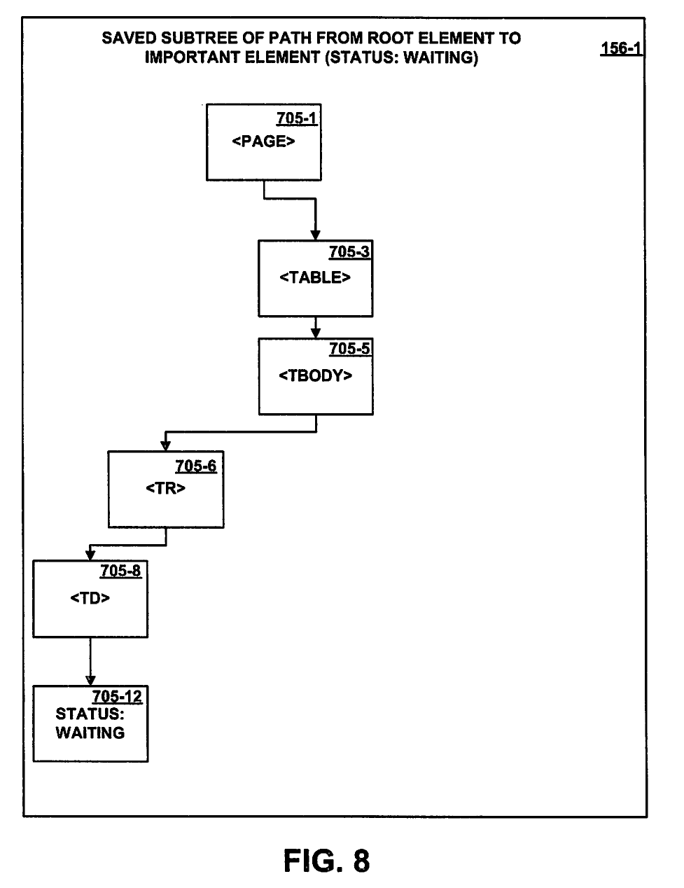

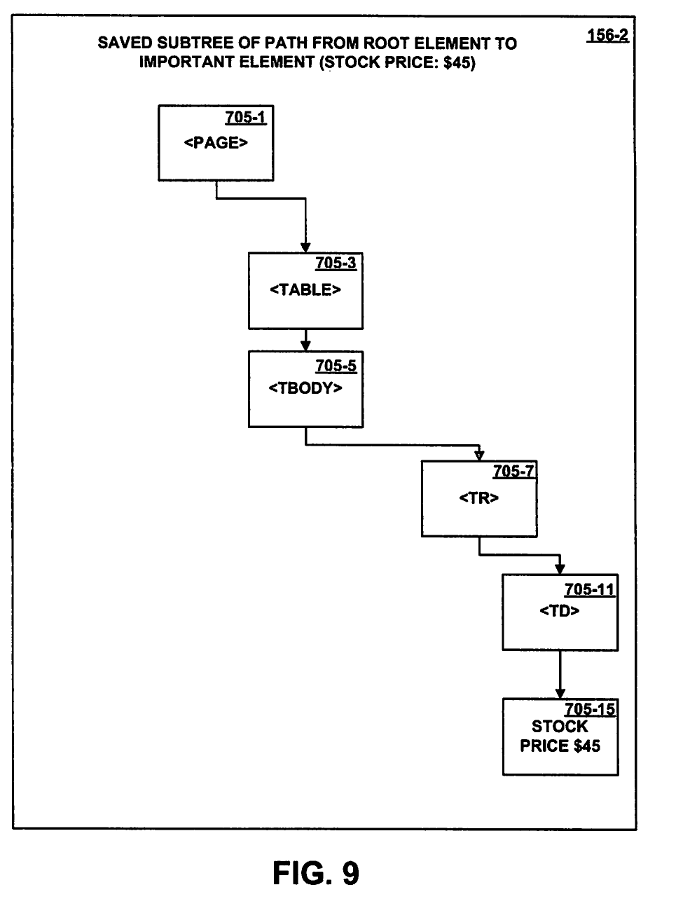

The saved subtree 156 represents a path that is a subset of the tree 154. The controller 150 uses the subtree 156 to save subsets of the page 152 that a user has selected as important. Examples of the saved subtree 156 are further described below with reference to FIGS. 8 and 9. The controller 150 saves information to the profile data 158 that describes the pages the user has retrieved and their selected important parent elements. An example of the profile data 158 is further described below with reference to FIG. 5.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, which may include user output devices (such as a video display device, speaker, and/or a Braille output device) and user input devices (such as a keyboard, mouse, touchpad, keypad, trackball, microphone, light pen, or other pointing device). The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network interface 114 provides one or more communications paths from the computer system 100 to other digital devices and computer systems 132; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100 and the server computer systems 132. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The server computer system 132 may include some or all of the hardware components previously described above as being included in the client computer system 100. In particular, the server computer system 132 includes memory 190 connected to a processor 194. The memory 190 is a random access semiconductor memory or other storage device that stores or encodes pages 152. The pages 152 may include any appropriate content that is capable of being retrieved by the controller 150, such as text, video, audio, images, control tags, formatting tags, statements, or any other appropriate data. In various embodiments, the pages 152 may be implemented via documents, files, objects, tables, databases, directories, subdirectories, or any portion or combination thereof and in some embodiments may include embedded control tags, format information, statements, or logic in addition to data.

It should be understood that FIG. 1 is intended to depict the representative major components of the client computer system 100, the network 130, and the server computer systems 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., and are referred to hereinafter as “computer programs,” or simply “programs.” The computer programs typically comprise one or more instructions that are resident at various times in various memory and storage devices in the client computer system 100, and that, when read and executed by one or more processors in the client computer system 100, cause the client computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the client computer system 100 and/or the server computer system 132 via a variety of tangible signal-bearing media that may be operatively or communicatively connected (directly or indirectly) to the processor or processors, such as the processor 101 and 194. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102 or 190, CD-RW, or diskette; or

(3) information conveyed to the client computer system 100 and/or the server computer system 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

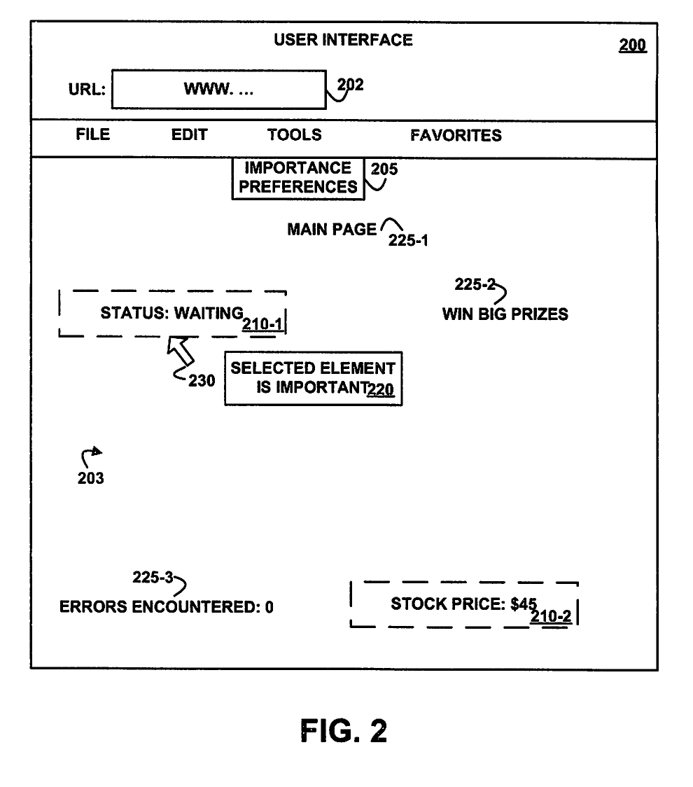

FIG. 2 depicts a block diagram of an example user interface 200, according to an embodiment of the invention. The controller 150 displays the example user interface 200 via the user terminal 121. The example user interface 200 includes a page address 202. The page address 202 identifies a page 152. The controller 150 may receive a page 202 address via explicit textual entry into the user interface 200, via selection of a hyperlink embedded in a displayed page, or via a selection of a favorites or bookmark entry. A hyperlink is an address, such as a URL (Uniform Resource Locator) of a linked page that is embedded in a linking page that, when selected, causes the linked page to be retrieved and presented to a user via the terminal 121. In various embodiments, the page address 202 is a partially or fully-qualified URL (Uniform Resource Locator) or other address that points at a page. A page address may include any, some, or all of a specification of a communication protocol, a port identifier, an address on the network 130, a domain identifier, a specification of a hierarchy of directories and subdirectories, and/or a file name that identifies a file, document, or page within the hierarchy of directories and subdirectories.

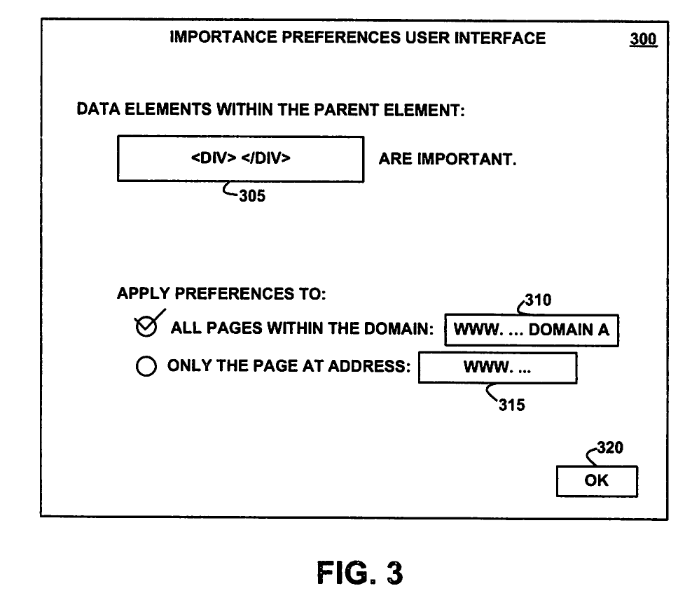

The user interface 200 further includes an importance preferences command 205, which in response to selection by a user via user terminal 121, is sent to the controller 150. In response to receiving the importance preferences command 205, the controller 150 displays an importance preferences user interface, as further described below with reference to FIG. 3.

The user interface 200 further includes a displayed page 203, which includes displayed data elements 210-1, 210-2, 225-1, 225-2, and 225-3. The controller 150 retrieved the page 152 (FIG. 1) from the address 202 at the server 132 and displayed the page 152 as the displayed page 203. The user interface 200 further includes a set important data element command 220 and a pointer 230.

As illustrated in FIG. 2, the user has selected the data element 210-1 via the pointer 230 and issued a set important data element command 220 to the controller 150, which identifies the element 210-1 and requests the controller 150 to designate the element 210-1 as important. The user has also selected the element 210-2 via the pointer 230 and issued a set important data element command 220 to the controller 150, which identifies the element 210-2 and requests the controller 150 to designate the element 210-2 as important. The user has not selected the elements 225-1, 225-2, and 225-3 and has not issued a set important data element command designating them as important.

The pointer 230 is a graphical image that indicates the location of a pointing device, such as a mouse, trackball, or trackpad. It can be moved and used via the user terminal 121 to select and move objects or commands. A pointer commonly appears as an angled arrow, but it can vary within different programs, e.g., text-processing applications often use an I-beam pointer that is shaped in the form of a capital “I,” but in other embodiments any appropriate shape or form for a pointer or type of selection or movement technique may be used.

FIG. 3 depicts a block diagram of an example user interface 300 for importance preferences, according to an embodiment of the invention. The controller 150 displays the user interface 300 via the user terminal 121 in response to receiving the importance preferences command 205, as previously described above with reference to FIG. 2. The user interface 300 includes an element preference field 305, a domain preference field 310, a page address preference field 315, and an OK button 320. The user enters an element preference into the element preference field 305 and a domain name into the domain preference field 310 or a page address into the page address preference filed 315 and selects the OK button 320, which sends the entered element preference 305 and domain name 310 or page address 315 to the controller 150 via a set important preferences command. The element preference 305 specifies a formatting element or control tag that, if present in a page 315 or in a page store at or within the specified domain 310 causes the controller 150 to treat that element as important. FIG. 2 illustrates an example element as “<div></div>,” but any appropriate element, control, or formatting tag may be specified.

The domain preference field 310 allows the user to input a domain to which the user desires the controller 150 to apply the element preference. In response to receiving the element specified in the element preference field 305 and the domain specified in the domain preference field 310, the controller 150 treats as important the specified element if the controller 150 finds that element within a page that was retrieved from a page address that is stored at a computer system that belongs to the specified domain. A domain is a group of one or more computers and/or other devices connected to the network 130 that are administered as a unit and share a common network address, e.g., an IP (Internet Protocol address). A network address is an identifier (typically a numeric identifier) for a computer or device on the network 130. Network addresses are usually assigned to domain names, which are textual names that are easier to remember than the numeric network addresses.

The page address preference field 315 allows the user to input a page address to which the user desires the controller 150 to apply the element preference. In response to receiving the element specified in the element preference field 305 and the page address specified in the page address field 315, the controller 150 treats as important the specified element if the controller 150 finds that element within a page whose address matches the address specified in the page address field 315.

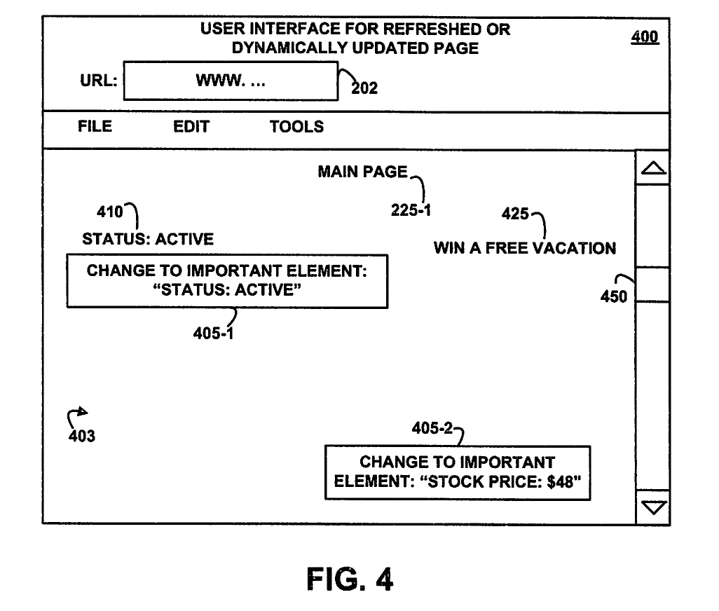

FIG. 4 depicts a block diagram of an example user interface 400 for a refreshed or dynamically updated page, according to an embodiment of the invention. The user interface 400 includes an address 202 of the refreshed or dynamically updated page, which is the same address as the address of the original page contents (illustrated in FIG. 2), a portion of which has now been changed via a page refresh or a dynamic update operation.

The user interface 400 further includes the displayed page 403, which includes the displayed elements 225-1, 410, and 425. The displayed element 225-1 is the same as was displayed in the original displayed page 203 (FIG. 2), so the refresh or dynamic update did not modify the displayed element 225-1. The displayed element 410 is different from the corresponding displayed element 210-1 (FIG. 2), and the displayed element 210-1 was selected by the user as being an important data element, so the controller 150 displayed the message 405-1 in the user interface 400, which indicates that the important data element has changed. The message 405-1 includes the updated value of the important data element. In another embodiment, the message also includes or indicates the parent element that includes the updated important data element. The displayed element 425 is different from the corresponding displayed element 225-2 (FIG. 2), but the displayed element 225-2 was not selected by the user as being an important data element, so the controller 150 does not display any message indicating that the displayed element 425 has changed the displayed element 225-2.

The elements 225-3 and 210-2 are not displayed within the displayed page 403 because the contents of the refreshed or dynamically-updated page are too large to fit within the displayed page 403. The contents may be too large to fit within the displayed page 403 because the user has resized the window of the user interface 400 to be too small to include all of the page because the contents exceed the size of the window or because a screen magnifier of the assistive technology 151 has increased the font size of the page to a size that reduces the amount of information that can be displayed within the window. Thus, the user interface 400 includes a scrollbar with a slider 450, which allows the user to request that the displayed area of the page to be moved to different contents of the refreshed or dynamically-updated page. Hence, although the elements 225-3 and 210-2 of the refreshed or dynamically are currently out of view and not within the displayed area of the user interface 400, the controller 150 may display them in response to user initiated movement of the slider 450 within the scrollbar.

The element 210-2 (FIG. 2) has been changed by the refresh or dynamic update, and the element 210-2 was selected by the user as being an important data element, so the controller 150 displayed the message 405-2 in the user interface 400, which indicates that the important data element 210-2 has changed, even though the element 210-2 is not currently displayed within the displayed page 403. The message 405-2 includes the updated value of the important data element. In another embodiment, the message also includes or indicates the parent element that includes the updated important data element.

FIG. 5 depicts a block diagram of an example data structure for the profile data 158, according to an embodiment of the invention. The profile data 158 includes example records 505, 510, and 515, each of which includes an example page address field 530, a saved subtree identifier field 532, an important parent element field 534, and a saved important data element field 536. The page address field 530 specifies a page or all pages within a specified domain that includes a selected important parent element. The saved subtree identifier field 532 identifies the saved subtree 156 that stores the saved important parent element and important data element. The important parent element field 534 identifies an element within the saved subtree 156 that is identified by the saved subtree identifier 532. The element in the important parent element field 534 was either selected by the user as important via the importance preferences user interface 300 or was selected by virtue of being the parent of the saved important data element 536, which the user selected via the command 220 of the user interface 200. In an embodiment, the saved important parent element 534 includes both a beginning and ending element or control tag, e.g., both “<div>” and </div>.” In another embodiment, the saved important parent element 534 stores only the beginning element (e.g., only “<div>”), and the controller infers the ending element (e.g., “</div>”) from the beginning element. The saved important data element field 536 identifies the data element, e.g., text or other data, within the important parent element 534 that the user has identified as important via the command 220.

FIG. 6 depicts a block diagram of an example data structure for a page 152, according to an embodiment of the invention. The page 152 includes example elements 605-1, 605-2, 605-3, 605-4, 605-5, 605-6, 605-7, 605-8, 605-9, 605-10, 605-11, 605-12, 605-13, 605-14, and 605-15. The elements 605-1, 605-2, 605-3, 605-4, 605-5, 605-6, 605-7, 605-8, 605-9, 605-10, and 605-11 are control or formatting elements and the elements 605-12, 605-13, 605-14, and 605-15 are text elements.

The elements of a page may have a hierarchical structure in that some elements may be inside or embedded within other elements, and the hierarchical structure may continue indefinitely. For example, the elements 605-2 and 605-3 are inside of and are children of the element 605-1; the element 605-4 is inside of and is a child of the element 605-2; the element 605-5 is inside and is a child of the element 605-3; the elements 605-6 and 605-7 are inside of and are children of the element 605-5; the elements 605-8 and 605-9 are inside of and are children of the element 605-6; the elements 605-10 and 605-11 are inside of and are children of the element 605-7; the element 605-12 is inside of and is a child of the element 605-8; the element 605-13 is inside of and is a child of the element 605-9; the element 605-14 is inside of and is a child of the element 605-10; and the element 605-15 is inside of and is a child of the element 605-11. The controller 150 interprets the elements of the page 152, in order to create the displayed page 203 of FIG. 2, and thus displays the elements 605-12, 605-13, 605-14, and 605-15 in the format specified by the elements 605-1, 605-2, 605-3, 605-4, 605-5, 605-6, 605-7, 605-8, 605-9, 605-10, and 605-11. The elements may also be referred to as nodes.

The displayed data elements 210-1 and 210-2 (FIG. 2) were selected as being important, and they correspond to and are implemented by the elements 605-12 and 605-15, respectively in the page 152.

FIG. 7 depicts a block diagram of an example data structure for a tree 154 that represents the page, according to an embodiment of the invention. The tree 154 represents the page 152, as previously described above with reference to page 6.

A tree represents a hierarchical organization of linked data. A tree takes its name from an analogy to trees in nature, which have a hierarchical organization of branches and leaves. For example, a leaf is connected to a small branch, which further is connected to a large branch, and all branches of the tree have a common starting point at the root. Analogously, nodes of a tree data structure have a hierarchical organization, in that a node has a relationship with another node, which itself may have a further relationship with other nodes, and so on. Thus, all of the nodes can be divided up into sub-groups and groups that ultimately all have a relationship to a root node.

To define a tree more formally, a tree structure defines the hierarchical organization of nodes, which can represent any data. Hence, a tree is a finite set, T, of one or more of the nodes, such that

a) one specially designated node is called the root of the tree; and

b) the remaining nodes (excluding the root) are partitioned into m>=0 disjoint sets T₁, . . . Tₘ, and each of these sets is in turn a tree.

The trees T₁, . . . , Tₘ are called the subtrees of the root. Thus, every node in a tree is the root of some subtree contained in the whole tree. The number of subtrees of a node is called the degree of that node. A node of degree zero is called a terminal node or a leaf. A non-terminal node is called a branch node. The level of a node with respect to T is defined by saying that the root has level 0, and other nodes have a level that is one higher than they have with respect to the subtree that contains them. Each root is the parent of the roots of its subtrees, and the latter are siblings, and they are also the children of their parent. The nodes in the subtrees of a root are the root's descendants. The root of the entire tree has no parent.

A different definition of a tree defines a tree as a connected acyclic simple graph. A simple graph has no multiple edges that share the same end nodes. An acyclic graph contains no cycles, where a cycle is a closed walk.

A walk is an alternating sequence of a subset of the nodes and edges of the graph, beginning with a first-node and ending with a last-node, in which each node in the walk is incident to the two edges that precede and follow it in the sequence, and the nodes that precede and follow an edge are the end-nodes of that edge. The walk is said to be closed if its first-node and last-node are the same or open if its first-node and last-node are different. An open walk is also called a path. In various embodiments, all of the edges in the walk may be different or distinct (in which case the walk is also known as a trail), or some of the edges in the walk may be the same. A walk may be formed from any type of the graph.

Thus, in FIG. 7, the tree 154 includes nodes 705-1, 705-2, 705-3, 705-4, 705-5, 705-6, 705-7, 705-8, 705-9, 705-10, 705-11, 705-12, 705-13, 705-14, and 705-15, which represent the respective elements 605-1, 605-2, 605-3, 605-4, 605-5, 605-6, 605-7, 605-8, 605-9, 605-10, 605-11, 605-12, 605-13, 605-14, and 605-15 of the page 152. The node 705-1 is the root node of the tree 154. The root node 705-1 has two child nodes 705-2 and 705-3. The node 705-2 has a child node 705-4, which is a leaf node because the node 705-4 has no children. The node 705-3 has a child node 705-5. The node 705-5 has two child nodes 705-6 and 705-7.

The node 705-6 has two child nodes 705-8 and 705-9. The node 705-8 has a child node 705-12, which is a leaf node. The node 705-9 has a child node 705-13, which is a child node because the node 705-13 has no children. The node 705-7 has two child nodes 705-10 and 705-11. The node 705-10 has a child node 705-14, which is a leaf node. The node 705-11 has a child node 705-15, which is a leaf node because the node 705-15 has no children.

The node 705-12 represents the element 605-12, which was selected by the user as being an important element. Thus, the parent node 705-8, the parent of the node 705-12, is the important parent node. The node 705-15 represents the element 605-15, which was selected by the user as being an important element. Thus, the parent node 705-11, the parent of the node 705-15, is the important parent node.

FIG. 8 depicts a block diagram of a saved subtree 156-1, according to an embodiment of the invention. The saved subtree 156-1 is an example of the saved subtree 156 (FIG. 1). The saved subtree 156-1 is a subset of the tree 154 and includes the nodes 705-1, 705-3, 705-5, 705-6, 705-8, and 705-12, which, in order, comprise a path from the root node 705-1 to the important data element, represented by the node 705-12. The node 705-8 is the important parent node of its child node, the node 705-12, which is a leaf node.

FIG. 9 depicts a block diagram of another saved subtree 156-2, according to an embodiment of the invention. The saved subtree 156-2 is an example of the saved subtree 156 (FIG. 1). The saved subtree 156-2 is a subset of the tree 154 and includes the elements 705-1, 705-3, 705-5, 705-7, 705-11, and 705-15, which, in order, comprise a path from the root node 705-1 to the important data element, represented by the node 705-15. The node 705-11 is the parent node (the parent element) of its child node, the node 705-15, which is a leaf node.

FIG. 10 depicts a flowchart of example processing for handling events, according to an embodiment of the invention. Control begins at block 1000. Control then continues to block 1005 where the controller 150 receives an event. In various embodiments, the controller 150 may receive the event in the form of a call or invocation, a message, a semaphore, an interrupt, a command, a request, or an RPC (Remote Procedure Call). The controller 150 may further receive the event by polling or monitoring for changes to data. The controller 150 may further receive the event from a user interface, from a method, component, module, or procedure external to the controller 150, or from a method, component, module, or procedure internal to the controller 150. The event may include data, such as parameters, which may be passed by value or by reference.

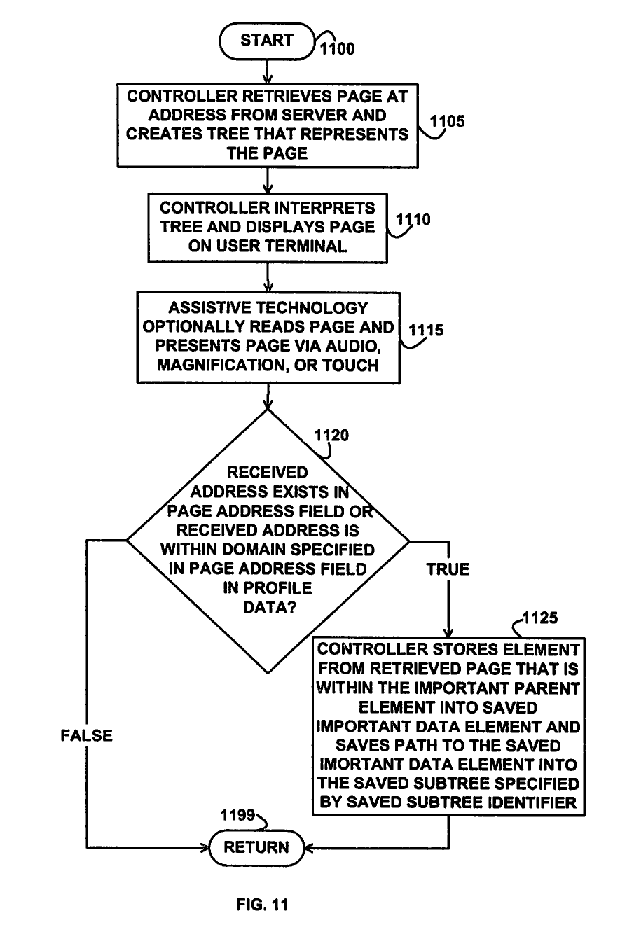

Control then continues to block 1010 where the controller 150 determines whether the received event is a page address received event. If the determination at block 1015 is true, then the received event is a page address received event, indicating that the controller 150 received a page address 202 (e.g., via explicit entry, via selection of an embedded hyperlink in a page, or via selection of an address from favorites or bookmark list or menu) from the user interface 200, so control continues to block 1015 where the controller 150 processes the received address 202 of a page, as further described below with reference to FIG. 11. Control then continues to block 1099 where the logic of FIG. 10 returns.

If the determination at block 1010 is false, then the received event is not a page address received event, so control continues to block 1020 where the controller 150 determines whether the received event is a set important data element event. Receipt of a set important data element event indicates that the controller 150 has received the set important data element command 220, which identifies an element 210-1 or 210-2 and requests the controller 150 to designate the identified element 210-1 or 210-2 as important.

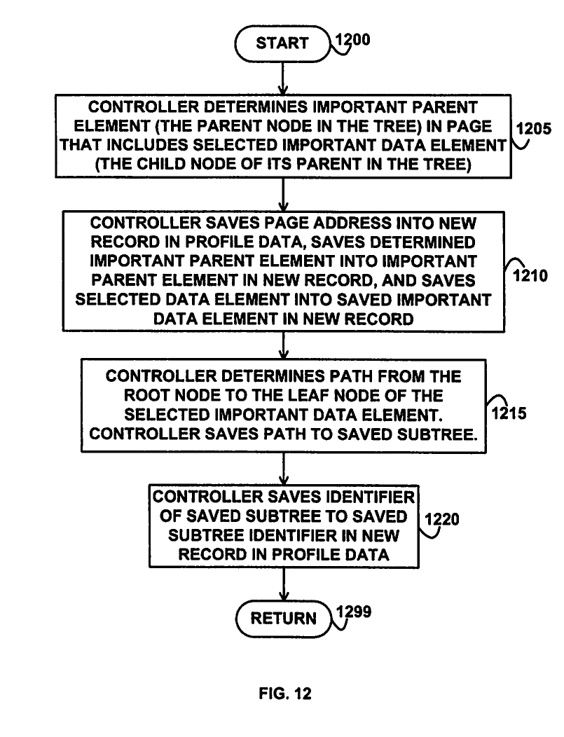

If the determination at block 1020 is true, then the received event is a set important data element event, so control continues to block 1025 where the controller 150 processes the set important data element event, as further described below with reference to FIG. 12. Control then continues to block 1099 where the logic of FIG. 10 returns.

If the determination at block 1020 is false, then the received event is not a set important data element event, so control continues to block 1030 where the controller 150 determines whether the received event is a set importance preferences event. Receipt of a set importance preferences event indicates that the controller 150 has received an element preference 305 and domain name 310 or page address 315 via a set important preferences command from the user interface 300.

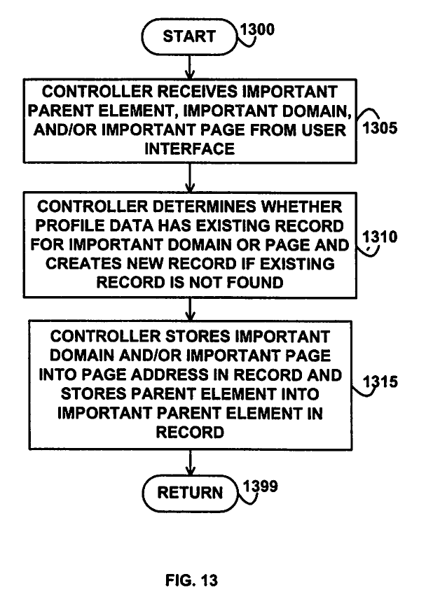

If the determination at block 1030 is true, then the received event is a set importance preferences event, so control continues to block 1035 where the controller 150 processes the set importance preferences event, as further described below with reference to FIG. 13. Control then continues to block 1099 where the logic of FIG. 10 returns.

If the determination at block 1030 is false, then the received event is not a set importance preferences event, so control continues to block 1040 where the controller 150 determines whether the received event is a page refresh or page dynamic update event. Receipt of a page refresh event indicates that the controller 150 received a new version of an entire page that had already been received. Both the new version and the previously-received version have the same page address. Receipt of a page dynamic update event indicates that the controller 150 has received only changed data for a portion of the previously-retrieved page. For both the page refresh and the page dynamic update, the controller 150 receives a change to a page had has already been retrieved.

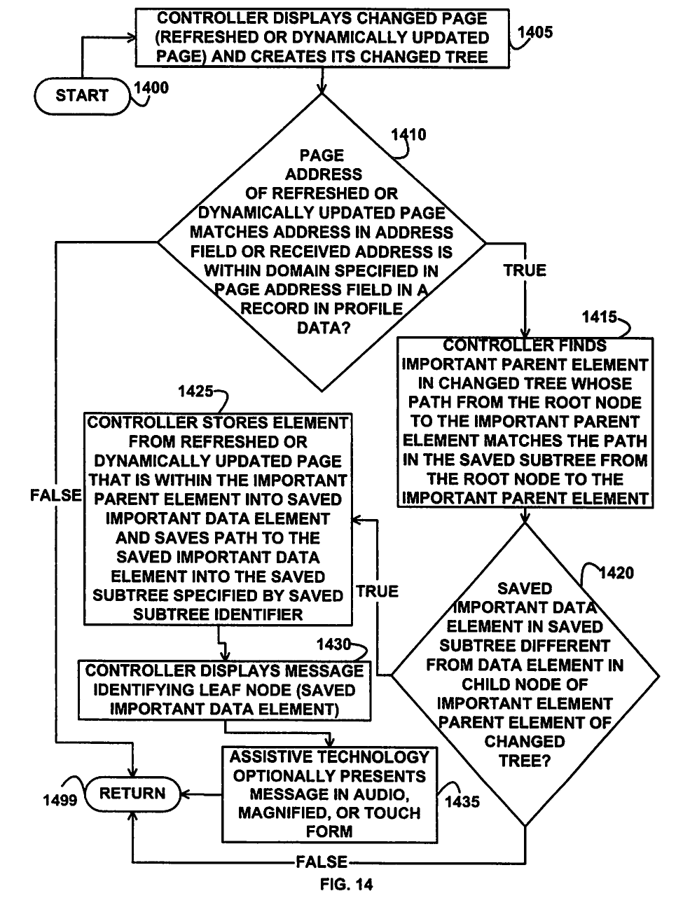

If the determination at block 1040 is true, then the received event is a page refresh or a page dynamic update event, so control continues to block 1045 where the controller 150 processes the page refresh or page dynamic update event, as further described below with reference to FIG. 14. Control then continues to block 1099 where the logic of FIG. 10 returns.

If the determination at block 1040 is false, then the received event is not a page refresh or a page dynamic update event, so control continues to block 1050 where the controller 150 processes other received events. Control then continues to block 1099 where the logic of FIG. 10 returns.

FIG. 11 depicts a flowchart of example processing for received addresses of pages, according to an embodiment of the invention. Control begins at block 1100. Control then continues to block 1105 where the controller 150 receives a page 152 from the address 202 at the server computer system 132 and creates the tree 154 that represents the page 152. Control then continues to block 1110 where the controller 150 interprets the tree 154 and displays the data elements of displayed page 203 in the format specified by the control formatting tag elements of the tree 154 on the user terminal 121 via the user interface 200, as previously described above with reference to FIG. 2.

Control then continues to block 1115 where the assistive technology 151 optionally reads the displayed page 203 and presents the page in audio form, magnified form, or touch output via the user terminal 121. Control then continues to block 1120 where the controller 150 determines whether the received address 202 of the displayed page matches (is identical to) a saved page address in the page address field 530 in a record in the profile data 158 or whether the received address 202 is within the domain specified in the page address field 530 in a record in the profile data 158. The determination at block 1120 is true if the controller 150 previously created a matching record in the profile data 158 in response to the set important data element event (FIGS. 2 and 12) or the set importance preferences event (FIGS. 3 and 13).

If the determination at block 1120 is true, then the received address 202 exists in a record in the page address field 530 in the profile data 158 or the received address 202 is within the domain specified in the page address field 530, so control continues to block 1125 where the controller 150 stores the important element (e.g., the element 605-12 or 605-15) from the retrieved page 152 that is within the important parent element 534 (that is the child element of the saved important parent element 534) into the saved important data element 536 in the record in the profile data 158 whose address 530 matches the received address 202. The controller 150 further determines the path of nodes from the root node 705-1 of the tree 154 to the leaf node (e.g., the node 705-12 or 705-15) that represents the saved important data element 536 and saves the determined path into the saved subtree 156 that is specified by the saved subtree identifier 532 in the record in the profile data 158 whose page address 530 matches the received page address 202. Control then continues to block 1199 where the logic of FIG. 11 returns.

If the determination at block 1120 is false, then the received address 202 does not exist in the page address field 530 of any record in the profile data 158 and the received address 202 is not within any domain specified in the page address field 530 of any records of the profile data 158, meaning that no elements of the page have been identified as important, so control continues to block 1199 where the logic of FIG. 11 returns without storing any data elements or any path to any saved subtree.

FIG. 12 depicts a flowchart of example processing for setting important data elements, according to an embodiment of the invention. Control begins at block 1200. Control then continues to block 1205 where the controller 150 determines the important parent element in the page 152 that includes selected data element (e.g., the element 210-1 or 210-2), i.e., the controller 150 determines the parent node (the important parent element) of the selected important data element (the child node of the parent node) within the tree that represents the page 152.

Using the examples of FIG. 2 and FIG. 7, if the selected important data element is the data element 210-1, then the data element 210-1 is represented by the node 705-12 in the tree 154, so the important parent element that the controller 150 determines at block 1205 is the parent node 705-8 (representing the element 605-8) of its child node 705-12. As another example, if the selected important data element is the data element 210-2, then the data element 210-2 is represented by the node 705-15 in the tree 154, so the important parent element that the controller 150 determines at block 1205 is the parent node 705-11 (representing the element 605-11) of its child node 705-15.

Control then continues to block 1210 where the controller 150 saves the page address 202 into the page address field 530 in a new record in the profile data 158, saves the determined important parent element into the important parent element field 534 in the new record, and saves the selected data element into the saved important data element field 536 in the new record.

Control then continues to block 1215 where the controller 150 determines the path from the root node to the leaf node of the selected important data element in the tree that represents the page. The controller 150 saves the determined path to a saved subtree 156.

Control then continues to block 1220 where the controller 150 saves an identifier of the saved subtree 156 to the saved subtree identifier field 532 in the new record in the profile data 158. Control then continues to block 1299 where the logic of FIG. 12 returns.

FIG. 13 depicts a flowchart of example processing for handling importance preferences, according to an embodiment of the invention. Control begins at block 1300. Control then continues to block 1305 where the controller 150 receives the important parent element 305, the important domain 310, and/or important page address 315 from the user interface 300.

Control then continues to block 1310 where the controller 150 determines whether the profile data 158 includes a record with a value in the page address field 530 that matches the received important domain 310 or the received important page address 315. If the controller 150 determines that the received important domain 310 or the important page address 315 already exists in the page address field 530 in a record in the profile data 158, then the controller 150 finds the existing record, which the controller 150 updates as further described below. If the controller 150 determines that the received important domain 310 or the important page address 315 do not already exist in the page address field 530 in a record in the profile data 158, then the controller 150 creates a new record in the profile data 158. The controller 150 then adds data to the new record in the profile data 158, as further described below.

Control then continues to block 1315 where the controller 150 stores the received important parent element 305 into the important parent element field 534 in the new or existing record in the profile data 158. The controller 150 further stores the important domain 310 into the page address field 530 of the new or existing record in the profile data 158 if the important domain 310 was received from the user interface 300. The controller 150 further saves the important parent element 305 into the important parent element field 534 in the new or existing record in the profile data 158.

Control then continues to block 1399 where the logic of FIG. 13 returns.

FIG. 14 depicts a flowchart of example processing for handling page refreshes and page dynamic updates, according to an embodiment of the invention. Control begins at block 1400. Control then continues to block 1405 where the controller 150 displays the changed page (displays the data elements of the refreshed or dynamically updated page 403) in the user interface 400, including any changes made to any data elements by the page refresh or dynamic update operation. The controller 150 further creates a changed tree that represents the refreshed or dynamically updated page.

Control then continues to block 1410 where the controller 150 determines whether the page address 202 of the refreshed or dynamically updated page (the changed page) matches a page address in the address field 530 or the received address 202 is within the domain specified in the page address field 530 of any record in the profile data 158. If the determination at block 1410 is true, then the page address 202 of the refreshed or dynamically updated page does match a page address in the address field 530 or the received address 202 is within the domain specified in the page address field 530 of a found record in the profile data 158, so control continues to block 1415 where the controller 150 searches for the important parent element 534 (from the found record) in the changed tree, where a path from the root node of the changed tree to the important parent element matches the path in the saved subtree 156 (identified by the saved subtree identifier 532 in the found record) from the root node to the important parent element. Paths match if they have the same number of nodes, their nodes are identical, and their identical nodes are in the identical order.

Control then continues to block 1420 where the controller 150 determines whether the saved important data element in the saved subtree 156 is different from (does not match) the data element in the child node (leaf node) of the important parent element of the changed tree. If the determination at block 1420 is true, then the saved important data element (leaf node) in the saved subtree 156 is different from (does not match) the important data element in the child node (leaf node) of the important parent element of the changed tree (hence the important data element 536 was changed by the refreshed or dynamically-updated changed page), so control continues to block 1425 where the controller 150 stores the important data element (from the refreshed or dynamically updated page) that is within the important parent element (i.e., that is a child node of the important parent element node) into the saved important data element field 536 of the found record and saves the path to the saved important data element into the saved subtree 156 specified by saved subtree identifier 532 of the found record.

Control then continues to block 1430 where the controller 150 displays the message 405-1 or 405-2 via the user terminal 121, which identifies the leaf node (the important data element) and optionally the important parent element 534. Control then continues to block 1435 where the assistive technology 151 optionally reads the displayed message 405-1 or 405-2 and presents the message in audio form, magnified form, or touch output form via the user terminal 121. Control then continues to block 1499 where the logic of FIG. 14 returns.

If the determination at block 1420 is false, then the saved important data element (leaf node) in the saved subtree 156 matches the important data element in the child node (leaf node) of the important parent element of the changed tree (hence the important data element 536 was not changed by the refreshed or dynamically-updated page), so control continues to block 1499 where the logic of FIG. 14 returns, without displaying the message 405-1 or 405-2.

If the determination at block 1410 is false, then the page address 202 of the refreshed or dynamically updated page does not match a page address in the address field 530 and the received address 202 is not within any domain specified in the page address field 530 of all records in the profile data 158 (hence the refreshed or dynamically updated page does not have any selected important data elements), so control continues to block 1499 where the logic of FIG. 14 returns.

Thus, in response to a refresh or dynamic update that changed a selected important data element in the page, the assistive technology 151 presents only that important data element (in the form of the message 405-1 or 405-2), but does not present data elements that have not been selected as important, even if they have changed.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
displaying a first subset of a page that comprises a first plurality of elements;
receiving a selection of an important element from the first subset;
creating a subtree that comprises a first path from a root element of a tree that represents the page to the important element;
receiving a changed page that comprises a second plurality of elements;
finding a second path in a changed tree that represents the changed page, wherein a leaf element of the second path is different from the important element in the first path, and wherein all other elements in the first path and the second path match; and
displaying a message that indicates the important element was changed.

2. The method of claim 1, wherein the finding further comprises:
determining that the all other elements from the root element to a parent element of the important element are identical and are in a same order.

3. The method of claim 1, wherein the displaying the first subset further comprises:
displaying the first subset of the plurality of elements in a format specified by a second subset of the plurality of elements.

4. The method of claim 1, further comprising:
presenting the message in an audio form.

5. The method of claim 1, further comprising:
presenting the message in a magnified form.

6. The method of claim 1, wherein the receiving the changed page further comprises:
receiving a refresh of the page.

7. The method of claim 1, wherein the receiving the changed page further comprises:
receiving a dynamic update to a portion of the page.

8. A method for deploying computing services, comprising:
integrating computer readable code into a computer system, wherein the code in combination with the computer system performs the method of claim 1.

9. A storage medium encoded with instructions, wherein the instructions when executed comprise:
receiving a page that comprises a first plurality of elements;
displaying a first subset of the first plurality of elements in a format specified by a second subset of the plurality of elements;
receiving a selection of an important element from the first subset;
creating a subtree, wherein the subtree comprises a first path from a root element of a tree that represents the page to the important element;
receiving a changed page that comprises a second plurality of elements;
finding a second path in a changed tree that represents the changed page, wherein the elements in the first path and the second path match from the root element to a parent of the important element;
if a leaf element of the second path is different from the important element in the first path, displaying the page and presenting a message via assistive technology that indicates the important element was changed; and
if the leaf element of the second path is identical to the important element in the first path, displaying the page.

10. The storage medium of claim 9, wherein the finding further comprises:
determining that the elements in the first path and the second path from the root element to the parent element are identical and are in a same order.

11. The storage medium of claim 9, wherein the presenting the message further comprises:
presenting the message in an audio form.

12. The storage medium of claim 9, wherein the presenting the message further comprises:
presenting the message in a magnified form.

13. The storage medium of claim 9, wherein the presenting the message further comprises:
presenting the message in touch output.

14. The storage medium of claim 9, wherein the receiving the changed page further comprises:
receiving a dynamic update to a portion of the page.

15. A computer system comprising:
a processor; and
memory connected to the processor, wherein the memory encodes instructions that when executed by the processor comprise:
receiving a page that comprises a first plurality of elements,
displaying a first subset of the first plurality of elements in a format specified by a second subset of the plurality of elements,
receiving a selection of an important element from the second subset;
creating a subtree, wherein the subtree comprises a first path from a root element of a tree that represents the page to a child element of the important element,
receiving a changed page that comprises a second plurality of elements,
finding a second path in a changed tree that represents the changed page, wherein a leaf element of the second path is different from the child element in the first path, and wherein all other elements in the first path and the second path match, and
displaying a message that indicates the important element was changed.

16. The computer system of claim 15, wherein the finding further comprises:
determining that the all other elements from the root element to a parent element of the important element are identical and are in a same order.

17. The computer system of claim 15, wherein the instructions further comprise:
presenting the message in an audio form.

18. The computer system of claim 15, wherein the instructions further comprise:
presenting the message in a magnified form.

19. The computer system of claim 15, wherein the receiving further comprises receiving a selection of a domain, and wherein the finding further comprises determining that an address of the changed page is within the domain.

20. The computer system of claim 15, wherein the receiving the changed page further comprises:
receiving a dynamic update to a portion of the page.
